(19) United States
(12) Patent Application Publication
(10) Pub. No.: US 2013/0141676 A1
(43) Pub. Date: Jun. 6, 2013

(54) LIQUID CRYSTAL DISPLAY DEVICE

(71) Applicants: Innocom Technology (Shenzhen) Co., Ltd., Shenzhen City (CN); Chimei Innolux Corporation, Chu-Nan (TW)

(72) Inventors: Chih-Yung HSIEH, Chu-Nan (TW); Ying-Jen CHEN, Chu-Nan (TW); Yi-Hsin CHEN, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/687,267

(22) Filed: Nov. 28, 2012

(30) Foreign Application Priority Data
Dec. 2, 2011 (TW) 100144312

(51) Int. Cl. G02F 1/1335

(52) U.S. Cl. CPC G02F 1/133528
USPC 349/96

(57) ABSTRACT

A liquid crystal display device is provided. The liquid crystal display device includes a first substrate having a pixel unit with a pixel electrode. A second substrate has an opposite electrode. A first polarizer is disposed under the first substrate. A second polarizer is disposed above the second substrate. A liquid crystal (LC) layer with chiral dopants is disposed between the first and second substrates. A parameter of the LC rotations of d/p ratios of the liquid crystal layer with chiral dopants is between 0.2 and 0.3. A parameter of the optical phase retardation factor R of the LC layer with chiral dopants is larger than 0.6 and less than 0.95.

### CROSS REFERENCE TO RELATED APPLICATIONS

This Application claims priority of Taiwan Patent Application No. 100144312, filed on Dec. 2, 2011, the entirety of which is incorporated by reference herein.

### BACKGROUND OF THE INVENTION

1. Field of the Invention

The present invention relates to a liquid crystal display device, and in particular, to a liquid crystal display device having a high-transmittance characteristic without gray-level inversion.

2. Description of the Related Art

The transmittance of a liquid crystal (LC) display device can be modified due to different polarizations or diffractions of an incident light by changing the arrangements of liquid crystal molecules, so that the LC display can produce images. The conventional twisted nematic (TN) device has good transmittance performance. However, the conventional TN device has a very narrow viewing-angle, which is limited by the structure and optical characteristics of the liquid crystal molecules. Therefore, it is a challenge for the LC display to have both a wide-viewing-angle and high utilization of light characteristics.

A vertical alignment (VA) type wide-viewing-angle LC display has been developed to solve the aforementioned problems. The VA type LC display comprises a patterned vertical alignment (PVA) type LC display, a multi-domain vertical alignment (MVA) type LC display, and etc. The PVA type LC display achieves the goal of wide-viewing-angle characteristics by applying a fringing-field effect thereto and optical compensation films. The MVA type LC display widens the viewing-angle and improves transmittance of the LC display by dividing a pixel area into multi domains and tilting liquid crystals respectively in the multi domains in several different directions using protrusion features or specific indium tin oxide (ITO) patterns.

The conventional VA type LC display, however, suffers from a gray-level inversion problem. The LC display theoretically has higher brightness at higher gray-levels (from gray-level of 0 (black) to gray-level of 255 (white)). But the LC display may have higher brightness at relatively lower gray-levels at certain large angles. In other words, when the LC display has a black and white reversal phenomenon, the gray-level inversion problem occurs. The gray-level inversion problem results in an unacceptable imaging quality for the LC display.

Thus, a novel liquid crystal display device with improved high-transmittance characteristics without gray-level inversion is desired.

### BRIEF SUMMARY OF INVENTION

A liquid crystal display is provided. An exemplary embodiment of a liquid crystal display device comprises a first substrate having a pixel unit. A second substrate is disposed opposite to the first substrate, having an opposite electrode. A first polarizer is disposed under the first substrate. A second polarizer is disposed under the second substrate, wherein a polarization axis of the second polarizer is vertical to that of the first polarizer. A liquid crystal (LC) layer with chiral dopants is disposed between the first and second substrates, wherein a parameter of the LC rotations (d/p ratio) of the LC layer with chiral dopants is between 0.2 and 0.3, and a parameter of the optical phase retardation factor R of the LC layer with chiral dopants is larger than 0.6 and less than 0.95, wherein

$$R = \frac{Δ nd}{λ} ,$$

wherein d is a thickness of the LC layer with chiral dopants, p is a pitch of chiral dopants, Δn is a birefringence coefficient of the LC layer with chiral dopants, and λ is a wavelength of an incident light.

Another exemplary embodiment of a liquid crystal display device comprises a first substrate having a pixel unit. A second substrate is disposed opposite to the first substrate, having an opposite electrode. A first polarizer is disposed under the first substrate. A second polarizer is disposed under the second substrate, wherein a polarization axis of the second polarizer is vertical to that of the first polarizer. A liquid crystal (LC) layer with chiral dopants is disposed between the first and second substrates, wherein a parameter of the optical path difference (Δnd) of the LC layer with chiral dopants is between 330 and 600, and a parameter of the LC rotations (d/p ratio) of the LC layer with chiral dopants is between 0.2 and 0.3, wherein Δn is a birefringence coefficient of the LC layer with chiral dopants, d is a thickness of the LC layer with chiral dopants, and p is a pitch of chiral dopants.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross sectional view showing one exemplary embodiment of a liquid crystal display device of the invention.

FIG. 2 is a top view showing one exemplary embodiment of electrode patterns of a liquid crystal display device of the invention.

FIG. 3a is a side view showing one exemplary embodiment of vertical alignment type liquid crystal molecules of one exemplary embodiment of a liquid crystal display device of the invention without an applied electronic field.

FIG. 3b is a side view showing one exemplary embodiment of vertical alignment type liquid crystal molecules of one exemplary embodiment of a liquid crystal display device of the invention with an applied electronic field.

FIG. 4a is a transmittance diagram showing a liquid crystal display device formed by a liquid crystal material without chiral dopants.

FIG. 4b is a transmittance diagram showing a liquid crystal display device formed by a liquid crystal material with chiral dopants.

FIGS. 5a to 5c are transmittance-voltage curve diagrams corresponding to different parameters of the LC rotations (d/p ratio) of a vertical alignment type liquid crystal display at zero-degree, 45-degree and 90-degree viewing-angles.

FIG. 6 is a transmittance-voltage curve diagram showing that the definition of the gray-level inversion.

FIG. 7 is transmittance distribution diagram corresponding to different parameters of the optical path difference (Δnd)) and LC rotations (d/p ratio) of one exemplary embodiment of a liquid crystal (LC) display device of the invention, which comprises an LC layer with chiral dopants, at a zero-degree viewing-angle.

FIGS. 8a and 8b are gray-level inversion value distribution diagrams corresponding to different parameters of the optical phase retardation factor R and LC rotations (d/p ratio) of one exemplary embodiment of a liquid crystal (LC) display device of the invention, which comprises an LC layer with chiral dopants, at 45-degree and 90-degree viewing-angles, respectively.

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the invention.

Embodiments provide a liquid crystal (LC) display device with improved transmittance characteristics in a display region without gray-level inversion. An LC material with chiral dopants is used as an LC layer of one embodiment of an LC display device of the invention.

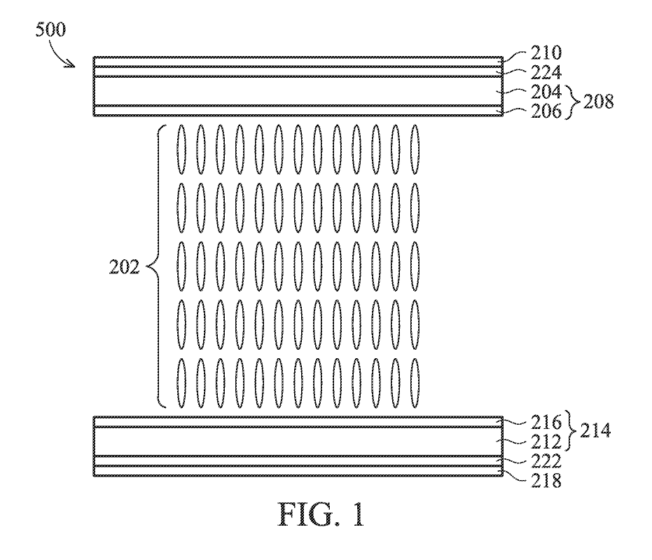

FIG. 1 is a cross sectional view showing one exemplary embodiment of a liquid crystal (LC) display device 500 of the invention. One exemplary embodiment of an LC display device 500 is a vertical alignment (VA) type LC display device. As shown in FIG. 1 the LC display device 500 comprises a first substrate 214 and a second substrate 208. The second substrate 208 is disposed opposite to the first substrate 214 and substantially parallel to the first substrate 214. In one embodiment, the first substrate 214 may serve as a thin film transistor (TFT) substrate, comprising a base 212, and at least one pixel unit. The pixel unit has a pixel electrode 216 and a TFT (not shown) disposed on the base 212. In one embodiment, the base 212 may comprise a glass substrate. Additionally, black matrixes (not shown) may be disposed between the pixel units.

The second substrate 208 may serve as a color filter (CF) substrate, comprising a base 204, an opposite electrode 206 and color filters (not shown). Additionally, black matrixes (not shown) may be disposed between the color filters.

The LC display device 500 further comprises a first polarizer 218 and a second polarizer 210. The first polarizer 218 is disposed under the first substrate 214, and the second polarizer is disposed above the second substrate 208. In one embodiment, a polarization axis of the second polarizer 210 is vertical to that of the first polarizer 218. In one embodiment, the LC display device 500 further comprises a first compensation film 222 disposed between the first substrate 214 and the first polarizer 218, and a second disposed between the second substrate 208 and the second polarizer 210.

As shown in FIG. 1, an LC layer 202 of the LC display device 500 is disposed between the first substrate 214 and the second substrate 208. In one embodiment, liquid crystal (LC) molecules of the LC layer 202 are formed by a nematic LC material, for example, a negative nematic LC or a positive nematic LC. Also, the LC layer 202 is added materials having optical activity, for example, chiral dopants. Therefore, the LC molecules of the LC layer 202 may twist along an axis direction, thereby having the optical activity, and the axis direction is parallel to a normal line of the first substrate 214.

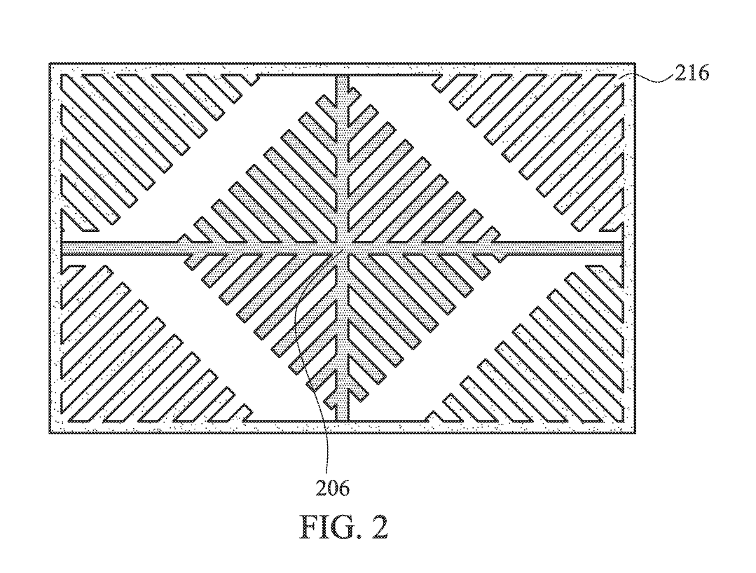

FIG. 2 is a top view showing one exemplary embodiment of electrode patterns of a liquid crystal display device of the invention. FIG. 2 illustrates electrode unit patterns of the pixel electrode 216 on the first substrate 214 (TFT side) and the opposite electrode 206 on the second substrate 208 (CF side).

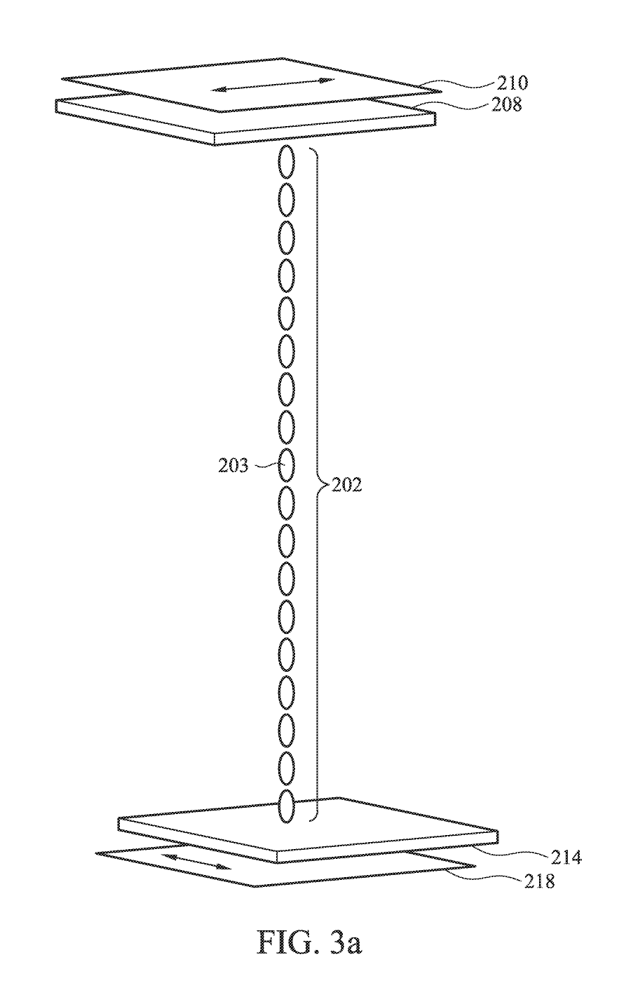

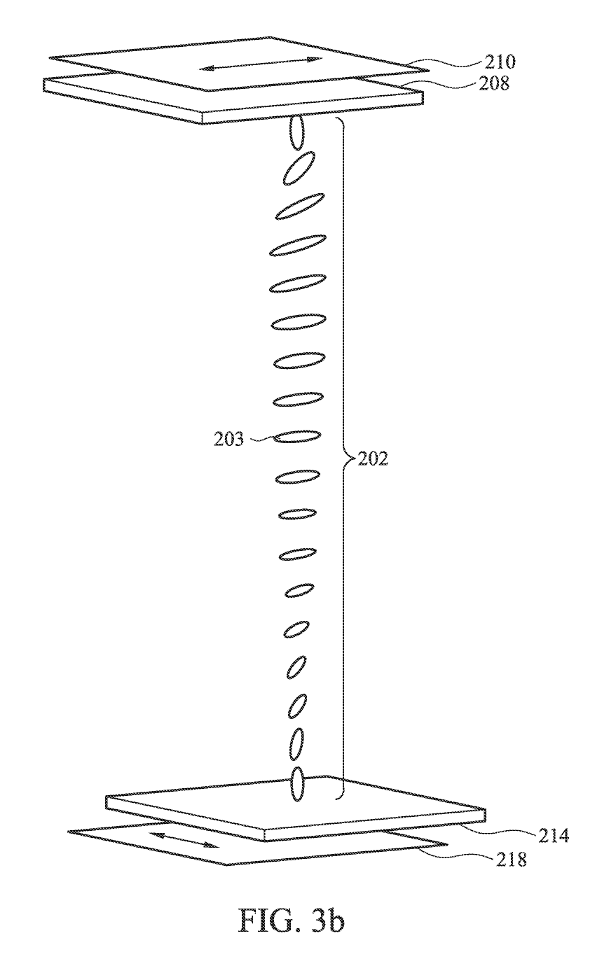

FIG. 3a is a side view of showing one exemplary embodiment of liquid crystal molecules 203 of the LC layer 202 of the liquid crystal display device 500 of the invention without an electronic field applied between the first substrate 214 and the second substrate 208. Directions of arrows on the first polarizer 218 and the second polarizer 210 illustrate directions of the polarization axis of the first substrate 214 and the second substrate 208, respectively. FIG. 3b is a side view of showing one exemplary embodiment of liquid crystal molecules 203 of the LC layer 202 of the liquid crystal display device 500 of the invention with an electronic field applied between the first substrate 214 and the second substrate 208. As shown in FIG. 3b, the LC molecules 203 are gradually twisted from the first substrate 214 to the second substrate 208, and the LC molecules 203 are gradually tilted to be arranged along a horizontal direction and then the LC molecules 203 are tilted from the horizontal direction to along a vertical direction. Along with increasing the applied electronic field, a range of the LC molecules 203 tilted to be a horizontal arrangement is increased. The twist angle of the LC molecules can be defined by controlling the concentration of chiral dopants. If a thickness of the LC layer is represented as d, a pitch of chiral dopants is represented as p, and a parameter of the LC rotations is represented as a d/p ratio.

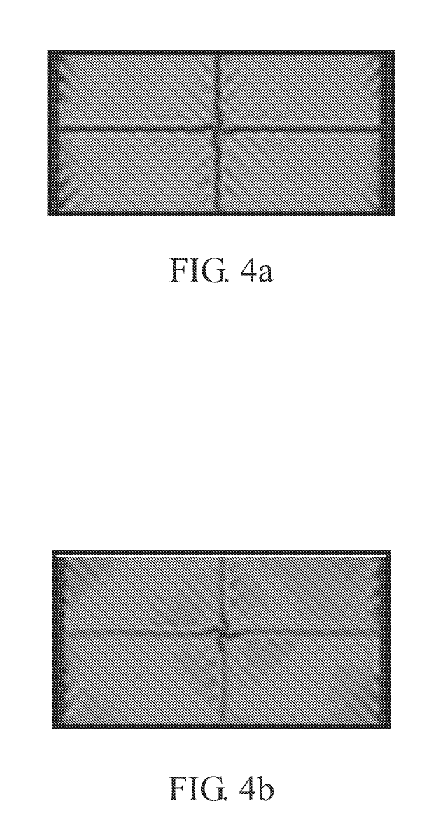

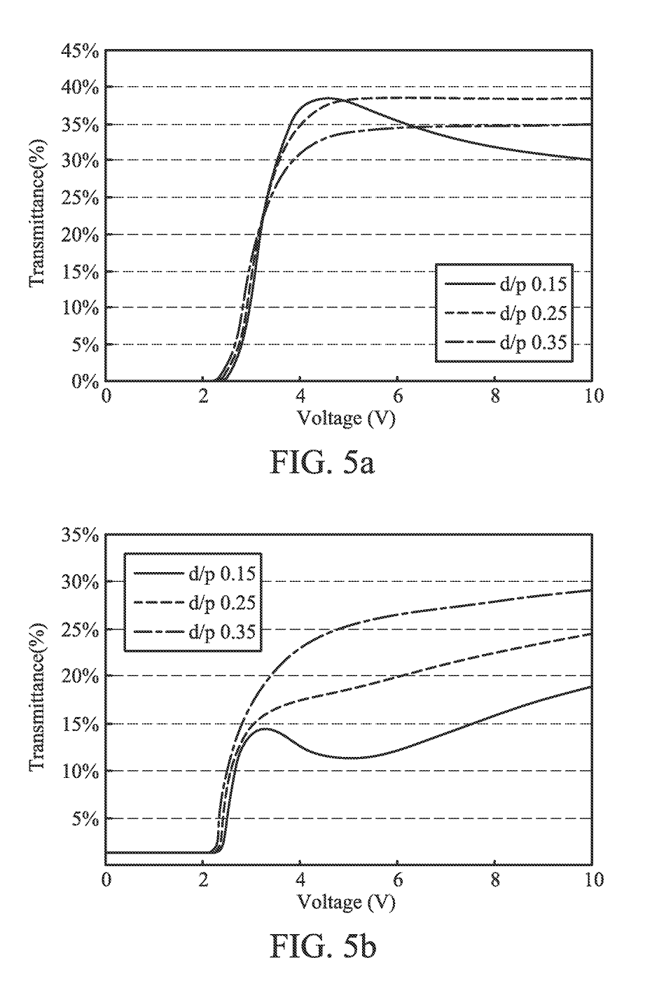

Please refer to FIGS. 4a and 4b. FIG. 4a is a transmittance diagram showing a liquid crystal display device formed by a liquid crystal material without chiral dopants. FIG. 4b is a transmittance diagram showing one exemplary embodiment of a liquid crystal display device formed by a liquid crystal material with chiral dopants. Electrode patterns of the liquid crystal display devices as shown in FIGS. 4a and 4b are the same as the electrode patterns as shown in FIG. 2. As shown in FIGS. 4a and 4b, because the LC molecules with chiral dopants can result in a macroscopic helical twist, the optical dark lines, which result from the non-tilting or tilting error problems of the LC molecules, in the display area of the liquid crystal display device as shown in FIG. 4a are thinner and lighter than the optical dark lines as shown in FIG. 4b. Therefore, the liquid crystal display device has high-transmittance characteristics.

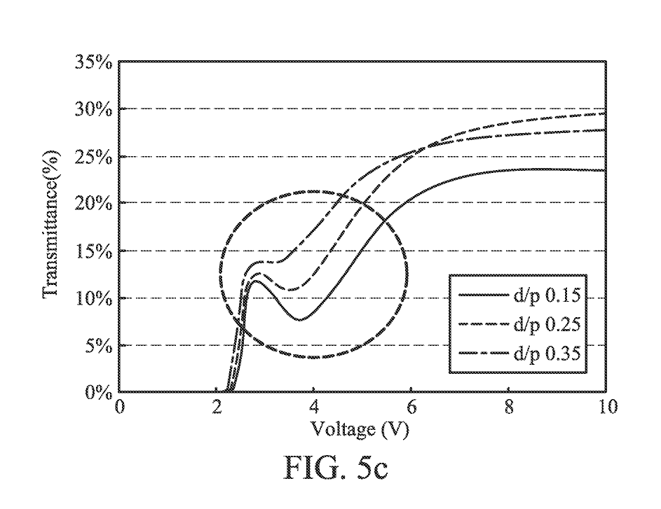

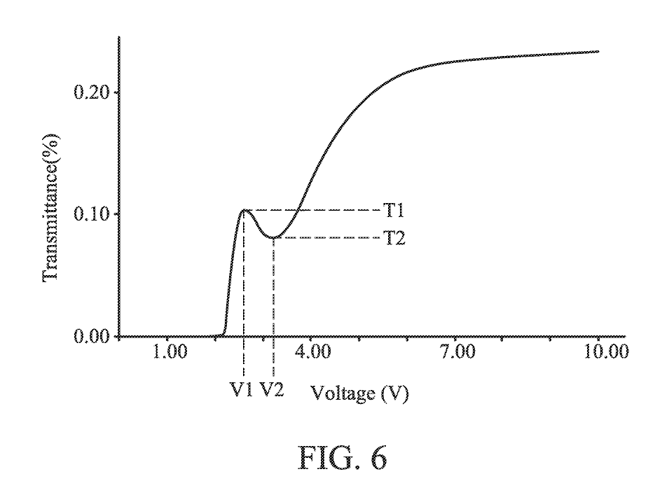

Please refer to FIGS. 5a to 5c and FIG. 6. FIGS. 5a to 5c are transmittance-voltage curve diagrams corresponding to different parameters of the LC rotations (d/p ratio) of a vertical alignment (VA) type liquid crystal (LC) display, which comprises an LC layer with chiral dopants, at a zero-degree viewing-angle (vertical viewing-angle), a 45-degree viewing-angle and a 90-degree viewing-angle (horizontal viewing-angle), wherein d is a thickness of the LC layer with chiral dopants, p is a pitch of chiral dopants, Δn is a birefringence coefficient of the LC layer with chiral dopants (also referred to as refractive index differences between the fast axis and slow axis of the LC layer with chiral dopants). FIG. 6 is a transmittance-voltage curve diagram to explain the definition of the gray-level inversion (also referred to as delta T). The corresponding transmittance decreases while the voltage increases (for example, from V1 to V2), the gray-level inversion occurs (in other words, when the transmittance T1 corresponding to the voltage V1 minus the transmittance T2 corresponding to the voltage V2 is larger than zero (delta T=T1-T2>0), the gray-level inversion occurs). As shown in FIG. 5a, the parameter of the LC rotations (d/p ratio) is as small as 0.15, and the corresponding transmittance decreases while the voltage increases. As shown in FIG. 5b, the gray-level inversion occurs while the VA type LC display has a small parameter of the LC rotations (d/p=0.15) at a 45-degree viewing-angle. As shown in FIG. 5c, the gray-level inversion becomes worse while the VA type LC display is at the horizontal viewing-angle. The gray-level inversion occurs while the parameters of the LC rotations (d/p ratio) are 0.15, 0.25 and 0.35.

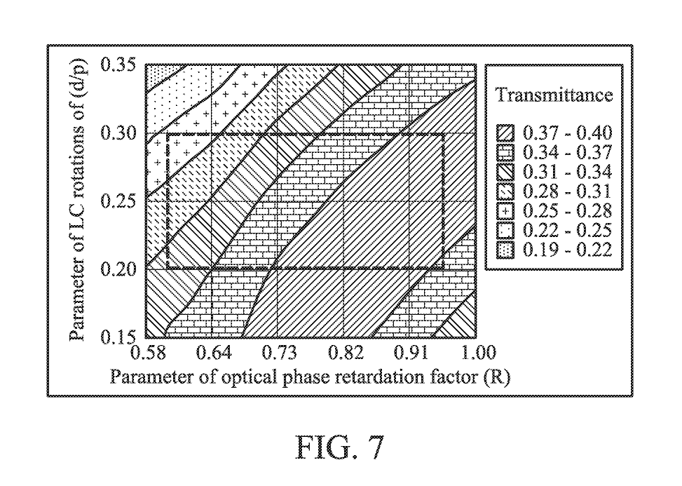

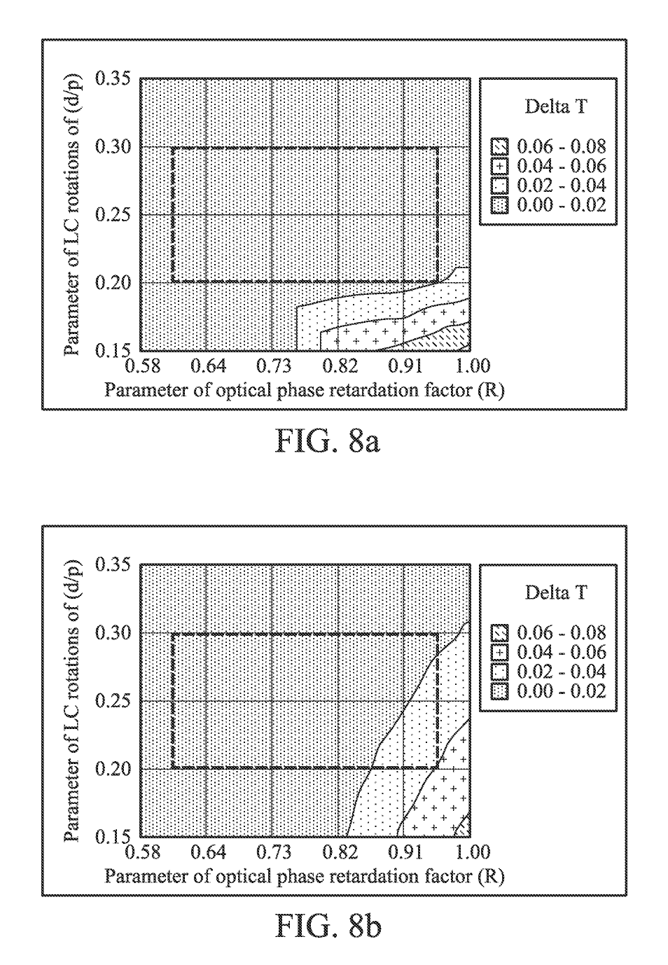

In order to find the preferred parameters of the optical phase retardation factor R, LC rotations (d/p ratio) and optical path difference (66 nd) of a vertical alignment (VA) liquid crystal (LC) display, which comprises an LC layer with chiral dopants, to improve the transmittance of the liquid crystal display device without gray-level inversion, the numerical simulation method is used to analyze and calculate the transmittance distribution corresponding to different parameters of the optical path difference (66 nd) and LC rotations (d/p ratio) of a display region of a liquid crystal (LC) display device, which comprises an LC layer with chiral dopants. When an incident light penetrates an LC layer having the birefringence characteristic, a parameter of the optical phase retardation factor R is represented as

$$\frac{Δ nd}{λ} ,$$

wherein λ is a wavelength of an incident light. FIG. 7 is transmittance distribution diagram corresponding to different parameters of the optical path difference (66 nd)) and LC rotations (d/p ratio) of one exemplary embodiment of a liquid crystal (LC) display device 500 of the invention, which comprises an LC layer with chiral dopants, at a zero-degree viewing-angle. In this embodiment, the LC display device 500 is operated by an incident light having a wavelength between 380 nm and 780 nm. FIGS. 8a and 8b are gray-level inversion (delta T) value distribution diagrams corresponding to different parameters of the optical phase retardation factor R and LC rotations (d/p ratio) of one exemplary embodiment of a liquid crystal (LC) display device 500 of the invention, which comprises an LC layer with chiral dopants, at 45-degree and 90-degree viewing-angles, respectively.

Please refer to FIGS. 7, 8a and 8b. In one embodiment, the parameters of the LC rotations (d/p ratio) and optical phase retardation factor R of the LC layer with chiral dopants of the LC display device 500 respectively satisfy equation (1) and equation (2) (corresponding to a region surrounded by a dotted line of FIG. 7). When the parameters of the LC rotations (d/p ratio) and optical phase retardation factor R of the LC layer with chiral dopants of the LC display device 500 respectively satisfy equation (1) and equation (2), the transmittance values of the LC display device 500 is between 0.25 and 0.4. Also, the gray-level inversion (delta T) value of the LC display device 500 at a 45-degree viewing-angle is not larger than 0.02 (corresponding to a region surrounded by a dotted line of FIG. 8a). Further, the gray-level inversion (delta T) value of the LC display device 500 at a 90-degree viewing-angle is not larger than 0.04 (corresponding to a region surrounded by a dotted line of FIG. 8b).

0.6<R<0.95 equation (1)

0.2≦d/p ≦0.3 equation (2)

When the parameter of the optical phase retardation factor R of the LC layer with chiral dopants of the LC display device 500, which is operated by an incident light having a wavelength between 380 nm and 780 nm, satisfies equation (1), the value of the optical path difference (66 nd) is between 228 nm and 741 nm. In one embodiment, the parameter of the optical path difference (66 nd) of the LC display device 500, which comprises an LC layer with chiral dopants, may preferably satisfy equation (3). When the parameters of the LC rotations (d/p ratio) and optical path difference (Δnd) of the LC display device 500, which comprises the LC layer 202 with chiral dopants, respectively satisfy equation (2) and equation (3), the gray-level inversion (delta T) value of the LC display device 500 at a 45-degree viewing-angle is not larger than 0.02 (corresponding to a region surrounded by a dotted line of FIG. 8a). Further, the gray-level inversion (delta T) value of the LC display device 500 at a 90-degree viewing-angle is not larger than 0.04 (corresponding to a region surrounded by a dotted line of FIG. 8b).

330≦Δnd≦600 equation (3)

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display device, comprising:
a first substrate having a pixel unit;
a second substrate disposed opposite to the first substrate, having an opposite electrode;
a first polarizer disposed under the first substrate;
a second polarizer disposed under the second substrate, wherein a polarization axis of the second polarizer is vertical to that of the first polarizer; and
a liquid crystal (LC) layer with chiral dopants disposed between the first and second substrates, wherein a parameter of the LC rotations (d/p ratio) of the LC layer with chiral dopants is between 0.2 and 0.3, and a parameter of the optical phase retardation factor R of the LC layer with chiral dopants is larger than 0.6 and less than 0.95, wherein
$$R = \frac{Δ nd}{λ} ,$$
wherein d is a thickness of the LC layer with chiral dopants, p is a pitch of chiral dopants, Δn is a birefringence coefficient of the LC layer with chiral dopants, and λ is a wavelength of an incident light.

2. The liquid crystal display device as claimed in claim 1, wherein the first substrate is a thin film transistor (TFT) substrate, and the second substrate is a color filter substrate.

3. The liquid crystal display device as claimed in claim 1, wherein the LC layer with chiral dopants is formed by a nematic LC material.

4. The liquid crystal display device as claimed in claim 1, wherein the liquid crystal display device is operated by an incident light having a wavelength between 380 nm and 780 nm.

5. The liquid crystal display device as claimed in claim 1, wherein a parameter of the gray-level inversion is not larger than 0.02 at a 45-degree

6. The liquid crystal display device as claimed in claim 1, wherein a parameter of the gray-level inversion is not larger than 0.04 at a 90-degree viewing-angle.

7. A liquid crystal display device, comprising:
a first substrate having a pixel unit;
a second substrate disposed opposite to the first substrate, having an opposite electrode;
a first polarizer disposed under the first substrate;
a second polarizer disposed under the second substrate, wherein a polarization axis of the second polarizer is vertical to that of the first polarizer; and
a liquid crystal (LC) layer with chiral dopants disposed between the first and second substrates, wherein a parameter of the optical path difference (66 nd) of the LC layer with chiral dopants is between 330 and 600, and a parameter of the LC rotations (d/p ratio) of the LC layer with chiral dopants is between 0.2 and 0.3, wherein Δn is a birefringence coefficient of the LC layer with chiral dopants, d is a thickness of the LC layer with chiral dopants, and p is a pitch of chiral dopants.

8. The liquid crystal display device as claimed in claim 7, wherein the first substrate is a thin film transistor (TFT) substrate, and the second substrate is a color filter substrate.

9. The liquid crystal display device as claimed in claim 7, wherein the LC layer with chiral dopants is formed by a nematic LC material.

10. The liquid crystal display device as claimed in claim 7, wherein the liquid crystal display device is operated by an incident light having a wavelength between 380 nm and 780 nm.

11. The liquid crystal display device as claimed in claim 7, wherein a parameter of the gray-level inversion is not larger than 0.02 at a 45-degree viewing-angle.

12. The liquid crystal display device as claimed in claim 7, wherein a parameter of the gray-level inversion is not larger than 0.04 at a 90-degree viewing-angle.
